(19) United States
(12) Patent Application Publication
(10) Pub. No.: US 2023/0321745 A1
(43) Pub. Date: Oct. 12, 2023

(54) WELDING TORCH WITH WIRE GUIDE

(71) Applicant: Lincoln Global, Inc., Santa Fe Spring, CA (US)

(72) Inventors: Jamil C. Snead, San Diego, CA (US); Stephen R. Cole, Chula Vista, CA (US)

(21) Appl. No.: 17/893,310

(22) Filed: Aug. 23, 2022

Related U.S. Application Data
(60) Provisional application No. 63/327,847, filed on Apr. 6, 2022.

(51) Int. Cl. B23K 9/12; B23K 9/16

(52) U.S. Cl. CPC B23K 9/122; B23K 9/16

(57) ABSTRACT

An electric arc torch includes a torch body and a gas diffuser extending from a distal side of the torch body. A contact tip is attached to the gas diffuser. The contact tip has a bore extending along a first axis. A wire guide is located within the torch body and has a wire guide channel that extends from a wire receiving end of the wire guide channel to a wire discharge end of the wire guide channel. The wire discharge end is aligned with the bore of the contact tip. A wire electrode conduit extends from a lateral side of the torch body and is configured to discharge a wire electrode into the wire receiving end of the wire guide channel and along a second axis. An angle between the first axis and the second axis is not greater than 90 degrees.

### CROSS-REFERENCE TO RELATED APPLICATIONS

The present application claims priority to U.S. Provisional Patent Application Ser. No. 63/327,847 filed on Apr. 6, 2022, the disclosure of which is incorporated herein by reference.

### BACKGROUND OF THE INVENTION

### Field of the Invention

The present invention relates to torches for generating electric arcs, and in particular to welding or additive manufacturing torches that deliver a wire electrode toward a workpiece during a deposition operation.

### Description of Related Art

One example torch that delivers a wire electrode toward a workpiece during a deposition operation is a gas metal arc welding (GMAW) torch. An example of a GMAW torch 100 is shown in FIG. 1. The wire electrode 102 is fed to the torch 100 by a wire feeder (not shown) and is fed through a torch cable 104. The wire electrode 102 typically enters the body of the torch 100 along the longitudinal axis of the torch (e.g., perpendicular to the workpiece 106). The wire electrode 102 feeds straight through the torch body and through a gas diffuser and contact tip within the torch. The axial arrangement of components within the torch 100, as well as the torch cable 104 supplying the wire electrode 102 from above the torch body, requires that there be a significant amount of clearance above the workpiece 106 during the deposition operation to accommodate the torch. It can be seen that the torch cable 104 curves into the top of the torch 100 and would require clearance space above the workpiece. It would be desirable to reduce the clearance above the workpiece that is required by the welding torch, to allow welding to occur within a more constricted overhead space and, in the case of orbital pipe welding, keep the welding equipment within a tight circle around the pipe to be welded.

### BRIEF SUMMARY OF THE INVENTION

The following summary presents a simplified summary in order to provide a basic understanding of some aspects of the devices, systems and/or methods discussed herein. This summary is not an extensive overview of the devices, systems and/or methods discussed herein. It is not intended to identify critical elements or to delineate the scope of such devices, systems and/or methods. Its sole purpose is to present some concepts in a simplified form as a prelude to the more detailed description that is presented later.

In accordance with one aspect of the present invention, provided is an electric arc torch. The electric arc torch includes a torch body and a gas diffuser extending from a distal side of the torch body. A contact tip is attached to the gas diffuser. The contact tip has a bore extending along a first axis. A wire guide is located within the torch body and has a wire guide channel that extends from a wire receiving end of the wire guide channel to a wire discharge end of the wire guide channel. The wire discharge end is aligned with the bore of the contact tip. A wire electrode conduit extends from a lateral side of the torch body and is configured to discharge a wire electrode into the wire receiving end of the wire guide channel and along a second axis. An angle between the first axis and the second axis is not greater than 90 degrees.

In accordance with one aspect of the present invention, provided is an electric arc torch. The electric arc torch includes a torch body and a gas diffuser extending from a distal side of the torch body. A contact tip is attached to the gas diffuser. The contact tip has a bore extending along a first axis. A wire guide is located within the torch body and has a wire guide channel that extends from a wire receiving end of the wire guide channel to a wire discharge end of the wire guide channel. The wire guide channel has a reverse curve shape formed by a first curved portion and a second curved portion curved in an opposite direction from the first curved portion. The first curved portion is located between the wire receiving end and the second curved portion, and is configured to turn a feeding direction of a wire electrode received at the wire receiving end by at least 90 degrees. The second curved portion is located between the first curved portion and the wire discharge end. The wire discharge end is aligned with the bore of the contact tip.

In accordance with another aspect of the present invention, provided is an electric arc torch. The electric arc torch includes a torch body and a contact tip. The contact tip has a bore extending along a first axis. A wire guide is located within the torch body and has a wire guide channel that extends from a wire receiving end of the wire guide channel to a wire discharge end of the wire guide channel. The wire discharge end is aligned with the bore of the contact tip. A wire electrode conduit extends from a lateral side of the torch body and is configured to discharge a wire electrode into the wire receiving end of the wire guide channel and along a second axis. An angle between the first axis and the second axis is not greater than 135 degrees.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 shows a prior art GMAW welding torch;

FIG. 2 is a perspective, partially transparent view of an example welding torch;

FIG. 3 is an exploded view of the torch shown in FIG. 2;

FIG. 4 is a cross-sectional view of the torch shown in FIGS. 2 and 3;

FIG. 5 is a perspective view of an example welding torch; and

FIG. 6 is a cross-sectional view of the torch shown in FIG. 5.

### DETAILED DESCRIPTION OF THE INVENTION

The present invention relates to torches for generating electric arcs, and in particular to welding or additive manufacturing torches. The present invention will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation, numerous specific details are set forth in order to provide a thorough understanding of the present invention. It may be evident, however, that the present invention can be practiced without these specific details. Additionally, other embodiments of the invention are possible and the invention is capable of being practiced and carried out in ways other than as described. The terminology and phraseology used in describing the invention is employed for the purpose of promoting an understanding of the invention and should not be taken as limiting.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. Any disjunctive word or phrase presenting two or more alternative terms, whether in the description of embodiments, claims, or drawings, should be understood to contemplate the possibilities of including one of the terms, either of the terms, or both terms. For example, the phrase “A or B” should be understood to include the possibilities of “A” or “B” or “A and B.”

While embodiments of the present invention described herein are discussed in the context of a gas metal arc welding (GMAW) torch, other embodiments of the invention are not limited thereto. For example, embodiments can be utilized in flux-cored arc welding (FCAW), metal-cored arc welding (MCAW), wire-fed gas tungsten arc welding (GTAW) as well as other similar types of welding operations. Further, embodiments of the present invention can be used in manual, semi-automatic and robotic welding operations, such as robotic orbital welding. Embodiments of the present invention can also be used in metal deposition operations that are similar to welding, such as additive manufacturing, hardfacing, and cladding. As used herein, the term “welding” is intended to encompass all of these technologies as they all involve material deposition to either join or build up a workpiece. Therefore, in the interests of efficiency, the term “welding” is used below in the description of exemplary embodiments, but is intended to include all of these material deposition operations, whether or not joining of multiple workpieces occurs.

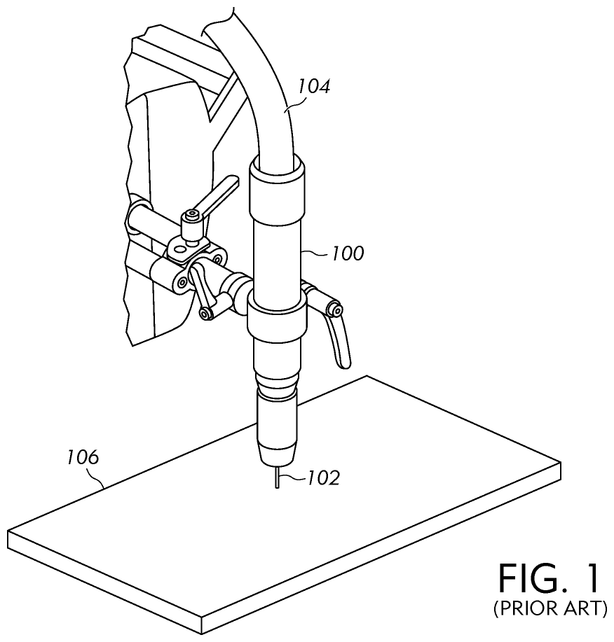

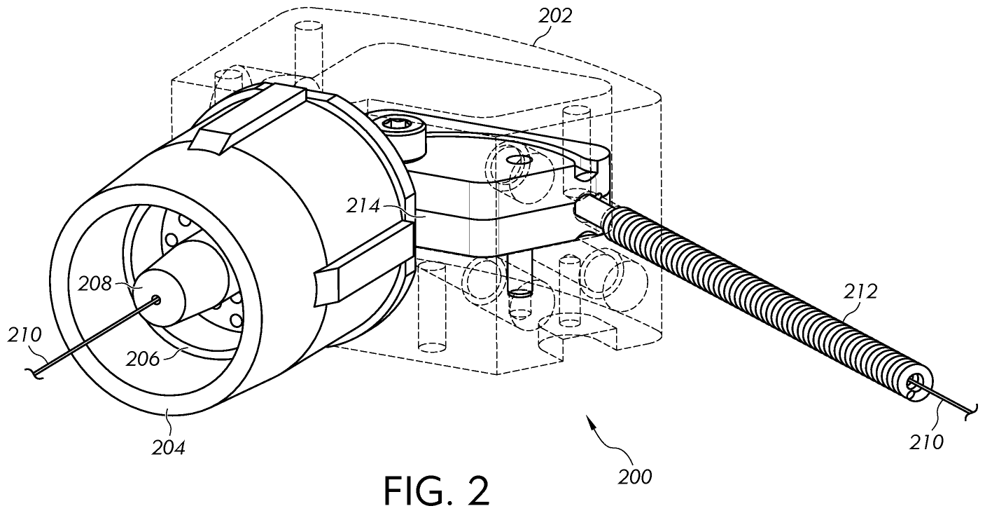

FIG. 2 shows an example welding torch 200. The torch 200 has a low profile as compared to the elongated, generally cylindrical torch shown in FIG. 1. The low profile is due to a shorter torch body 202. The shorter torch body 202 is made possible by feeding or connecting the wire electrode, shielding gas, and optional liquid cooling conduits into a lateral side of the torch 200, rather than along the longitudinal axis of the torch and into the top or proximal end of the torch. The torch's low profile reduces the required overhead clearance above the workpiece needed during a deposition operation, such as during welding or additive manufacturing, as compared to the conventional torch shown in FIG. 1. In an example embodiment, the length of the torch 200 from the top or proximal end or side of the torch to its distal end or side at the bottom or terminal end of nozzle 204, can be less than 6 inches (152 mm). The proximal end or side of the torch is opposite the distal end or side at the bottom/terminal end of the nozzle 204. In example embodiments, the length of the torch can be between 2 inches (51 mm) and 6 inches, or about 3 inches (76 mm), 4 inches (102 mm), 5 inches (127 mm) or greater or less than 3 inches. In an example embodiment, the torch 200 is designed for operation within a 3 inch clearance (e.g., overhead clearance) of a workpiece, which could be a flat workpiece or a pipe. To operate within a 3 inch clearance, the torch 200 can have a length of 3 inches or slightly less (e.g., between 3 inches and 2.75 inches or 70 mm).

Extending from the torch body 202, in particular from the bottom or distal side of the torch body, is the nozzle 204. The nozzle 204 directs shielding gas from the torch 200 toward the workpiece during welding. The nozzle 204 is attached to a gas diffuser 206. The gas diffuser 206 extends from the distal side of the torch body 202 and axially into the bore of the nozzle 204. A contact tip 208 is attached to the gas diffuser 206. The contact tip 208 conducts electricity to the wire electrode 210 during welding to generate the arc. The diffuser 206 discharges the shielding gas from the torch 200 into the nozzle 204 and toward the workpiece, to shield the arc and weld zone or molten puddle. The contact tip 208 can be made of a highly electrically conductive material, such as copper, whereas the nozzle 204 can be made from an electrical insulator, such as alumina for example. However, other materials of construction are possible. For example, the nozzle 204 could be made from a metallic material if electrical insulation is not required.

Also extending from the torch body 202 is a wire electrode conduit 212 for conveying the wire electrode 210 into the torch 200. A wire feeder (not shown) feeds the wire electrode 210 from a spool or drum into the torch 200 through the conduit 212. It can be seen that the wire electrode conduit 212 is attached to the torch body 202 along a lateral side of the torch 200, rather than at the upper or proximal side of the torch body opposite the nozzle 204, contact tip 208 and diffuser 206. The wire electrode conduit 212 extends away from the lateral side of the torch body 202. The torch 200 includes a wire guide 214 located within the torch body 202. The wire guide 214 receives the wire electrode 210 from the conduit 212, and directs the wire electrode to the bore in the contact tip 208. The wire guide 214 bends the wire electrode 210 from the lateral side of the torch body 202 to the bottom or distal side of the torch body and into the contact tip 208.

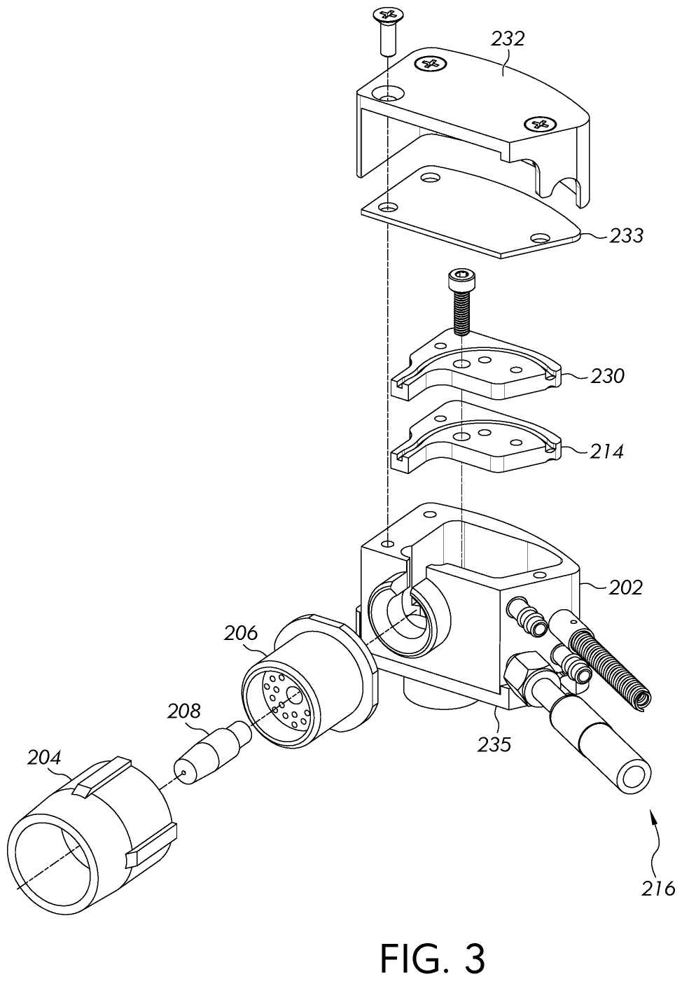

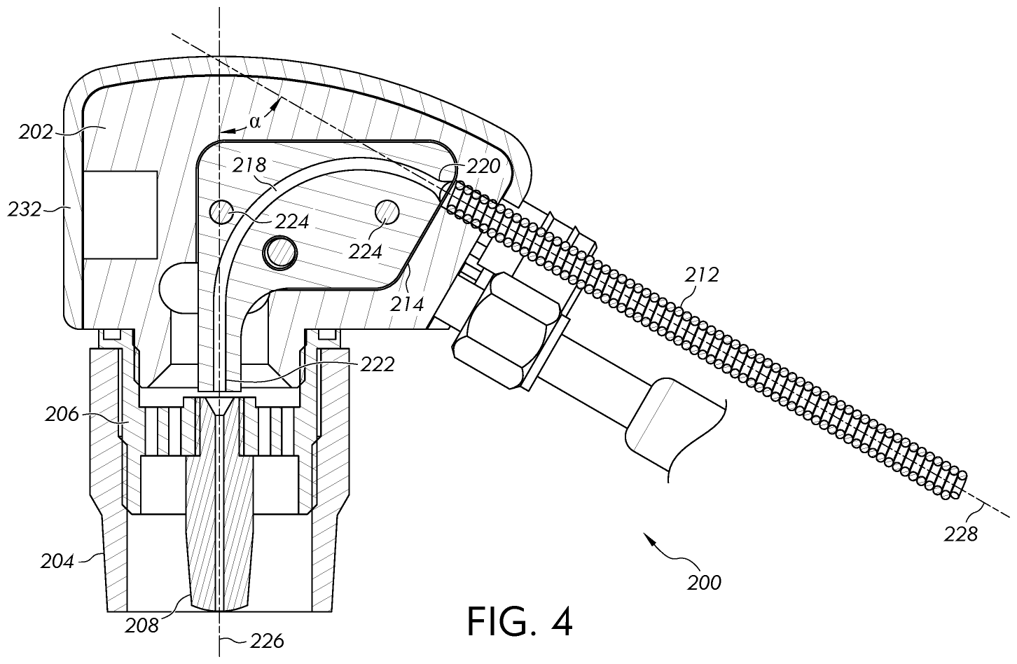

FIG. 3 is an exploded view of the torch 200 and FIG. 4 is a cross-sectional view of the torch. In addition to the wire electrode conduit 212 connected to the torch 200 along one of its lateral sides, additional conduits 216, such as conduits for the shielding gas, cooling liquid, welding power, voltage sensing, etc. can also be connected to the torch along one of its lateral sides. To maintain the short, low profile shape of the torch 200, the additional conduits 216 can be connected to the same lateral side of the torch as the wire electrode conduit 212 or to a different lateral side of the torch, rather than to the top or proximal side of the torch.

As noted above, the wire guide 214 bends the wire electrode from the lateral side of the torch body 202 to the bottom or distal side of the torch body and into the contact tip 208. The wire guide 214 has a wire guide channel 218. The wire guide channel 218 extends from a wire receiving end 220 of the channel to a wire discharge end 222 of the channel. The wire receiving end 220 of the wire guide channel 218 is aligned with the terminal end of the wire electrode conduit 212 within the torch body 202. The wire electrode conduit 212 discharges the wire electrode into the wire receiving end 220 of the wire guide channel 218 during wire feeding. The wire electrode is bent by the wire guide channel 218 and directed into the central bore of the contact tip 208. The wire discharge end 222 of the wire guide channel 218 is aligned with the central bore of the contact tip 208.

The wire guide 214 may need to be replaced from time to time due to wear from abrading during wire feeding. To facilitate the proper placement of the wire guide 214 within the torch body 202, the wire guide and/or the torch body can include positioning structures such as slots, protrusions, matching surfaces, and the like. The example torch 200 shown in the figures includes guide pins 224 to help ensure that the wire receiving end 220 and the wire discharge end 222 of the wire guide channel 218 are properly aligned with the wire electrode conduit 212 and contact tip 208 bore, respectively.

The wire guide 214 can be formed from a metallic material, such as steel (e.g., hardened tool steel) or a nonmetallic material, such as a ceramic. Good feedability and high abrasion resistance are two factors to consider when selecting a material for the wire guide, and hardened tool steel and ceramic materials meet these requirements. The wire guide 214 could be formed from a heat treated material to improve its feedability/abrasion resistance. The wire guide 214 can be a rigid component that is formed from a solid block of material, with the wire guide channel 218 cut into it. The wire guide 214 could also be manufactured by 3D printing or laser sintering. A benefit of forming the wire guide 214 from a solid block of material with the wire guide channel 218 cut into it is that it would be relatively easy to manufacture on basic machining equipment. Moreover, the wire guide channel 218 could have various shapes within the 2D plane, such as a reverse curve (also known as an S curve) or zig zag or squiggle shape, without impacting manufacturability. In the embodiment shown in the FIG. 4, the wire guide channel 218 has a central curved portion with a constant radius, and the central curved portion is located between the wire receiving end 220 of the channel and the wire discharge end 222. At its terminal portion, near its wire discharge end 222 and the contact tip 208, the wire guide channel 218 is straight. The wire guide channel 218 could have other straight portions, such as at the wire receiving end 220, or no straight portions. The central curved portion of the wire guide channel 218 could also have a changing radius (e.g., increasing or decreasing) along its length. In certain embodiments, the wire guide channel 218 can include a reverse bend located after the primary bend shown in the figures, to straighten the wire electrode before it is discharged from the torch. Including a reverse bend after the primary bend can be desirable if the primary bend is so tight that it imparts a permanent bend to the wire electrode. The wire guide channel 218 could include bearings (e.g., ball bearings) along its length to reduce wear and drag when feeding the wire electrode through the wire guide 214.

The wire guide channel 218 is narrow and it forces the wire electrode around the desired bend and into the contact tip 208. The radius of the central curved portion of the wire guide channel 218 can be based on the desired torch length/height or desired necessary clearance above the workpiece. In an example embodiment, the radius of the curved portion of the wire guide channel 218, e.g., at its outer edge, inner edge or at its center, is 1 inch (25 mm) or less (e.g., 0.75 inches or 19 mm). In general, the radius of the curved portion of the wire guide channel 218 should be are large as possible while still maintaining a desired torch height or torch length (e.g., 3 inches or less). As the radius of the wire guide channel 218 decreases, its bend is tightened and the force required to push the wire electrode through the channel increases, as does the likelihood of introducing a permanent bend into the electrode, which will cause the wire electrode to exit the contact tip 208 crooked. The angle of the turn provided by the wire guide 214 and its dynamic friction with the wire electrode also impacts the force required to push the wire electrode through the channel 218. In the example embodiment shown, the angle of the turn provided by the wire guide 214 is greater than 90 degrees (e.g., about 120 degrees). In an embodiment, the central curved portion of the wire guide channel 218 is configured to turn or change the feeding direction of the wire electrode received from the conduit 212 at the wire receiving end of the channel by at least 90 degrees. In the embodiment shown in FIG. 4, the central curved portion of the wire guide channel 218 turns or changes the feeding direction of the wire electrode by about 120 degrees from the wire receiving end of the wire guide channel to its wire discharge end, although various angles of turn or alteration are possible. For orbital pipe welding applications, it may be desirable to provide a greater amount of turn or bending of the wire electrode via wire guide 214 versus flat plate welding applications, in order to keep the welding equipment (e.g., weld head and cables/conduits) within a tight circle around the pipe to be welded.

As illustrated in FIG. 4, the contact tip 208 and its bore for the wire electrode extend along a first axis 226. The wire electrode conduit 212 extends along a second axis 228. The wire electrode conduit 212 discharges the wire electrode into the wire receiving end 220 of the wire guide channel 218 along the second axis. Upon entering the wire guide channel 218, the wire electrode is quickly bent away from the second axis 228 and toward the first axis 226 for delivery to the contact tip 208. The first axis 226 and the second axis 228 form an angle α between them. The angle α could be any angle that is desired (e.g., less than 180 degrees, not greater than 135 degrees, not greater than 120 degrees, not greater than 90 degrees, etc.) In certain example embodiments, the angle α is not greater than 90 degrees so that the wire electrode enters the torch body 202 horizontally or in an upward direction as shown. In the example embodiment illustrated in FIG. 4, the angle α is 60 degrees. However, the angle α could be greater or less than 60 degrees if desired, such as 45 degrees, 50 degrees, 55 degrees, 65 degrees, 70 degrees, 75 degrees, 80 degrees, 85 degrees, 90 degrees, 95 degrees, 100 degrees, 120 degrees, 135 degrees, greater than 135 degrees, or an intervening angle between those listed herein. The angle α could be any angle that is desired such that the torch 200 maintains an acceptable length or will remain within an acceptable overhead window above the workpiece.

The wire guide channel 218 can be an open channel along its length from the wire receiving end 220 to the wire discharge end 222, as best seen in FIG. 3. To enclose the channel 218 and capture the wire electrode within the channel, the torch 200 can include a plate that sits atop the wire guide 214. In an example embodiment, the plate can be a spare wire guide 230 that is identical to the lower wire guide 214. Should the lower wire guide 214 wear out over time, it can be replaced with the spare wire guide 230 stored in the torch body 202. The spare wire guide 230 is located within the torch body 202 atop the wire guide 214 that is in use. The lower surface of the spare wire guide 230 opposite its wire guide channel closes off the open wire guide channel 218 of the wire guide 214 that is in use. Although FIG. 3 shows a single spare wire guide 230 located within the torch body 202, the torch could include multiple spare wire guides stored within the torch body in addition to the primary wire guide 214 that is in use.

Rather than having an open wire guide channel 218, the wire guide 214 could have an enclosed curved bore to convey the wire electrode to the contact tip 208. In other embodiments, the wire guide could include a bent tube extending between the wire electrode conduit 212 and the contact tip 208. The bent tube could be either rigid or flexible. Example materials of construction for a bent tube wire guide include a solid metal tube, a spiral wound metal tube (e.g., similar to a welding wire liner), or a plastic tube. If a flexible tube is used as a wire guide, it could be retained within the torch body 202 at the wire receiving and discharge ends, with the central curved portion of the tube floating free within a void in the torch body. The torch body 202 could include a channel or other positioning or retaining structures to keep a flexible tube wire guide in place. In further embodiments, the wire guide can be a structure that is integrally formed with (e.g., a part of) the torch body 202. That is, the torch body 202 itself would form the wire guide channel. However, torch bodies are typically made of copper or brass because they require good electrical conductivity, and those materials are not optimal for wire feedability or abrasion resistance. Additionally, if the channel in the torch body 202 were to wear out, then the entire torch body would have to be replaced, which would be more costly than replacing just a dedicated wire guide.

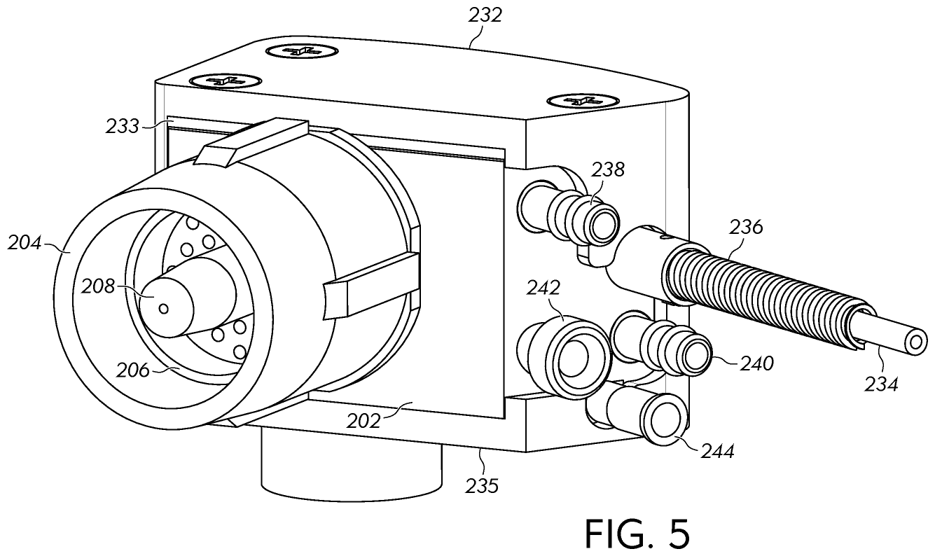

With reference to FIG. 5, the torch 200 can include an outer or top cover 232 that provides access to the interior of the torch body 202 and the wire guides 214, 230. The cover 232 can also provide electrical insulation around the torch body 202, which will be energized during a deposition operation. The torch 200 can include a gasket 233 between the cover 232 and the torch body 202. The torch 200 can further include a bottom cover 235, which may provide similar functionality as the top cover 230. In certain embodiments, the wire electrode conduit can include a smooth, low-friction inner liner 234 (e.g., made of plastic) and a flexible outer conduit 236 (e.g., made from a metallic material) that protects the inner liner. Fittings and connections for various additional conduits extending from the same lateral side of the torch body 202 as the wire electrode conduit can be seen in FIG. 5. In particular, the torch can include a shielding gas fitting 238, a cooling liquid fitting 240, a welding power connector/cooling liquid discharge fitting or connector 242, and a voltage sense connector 244. The various connectors and fittings need not be on the same lateral side as each other or on the same lateral side as the wire electrode conduit.

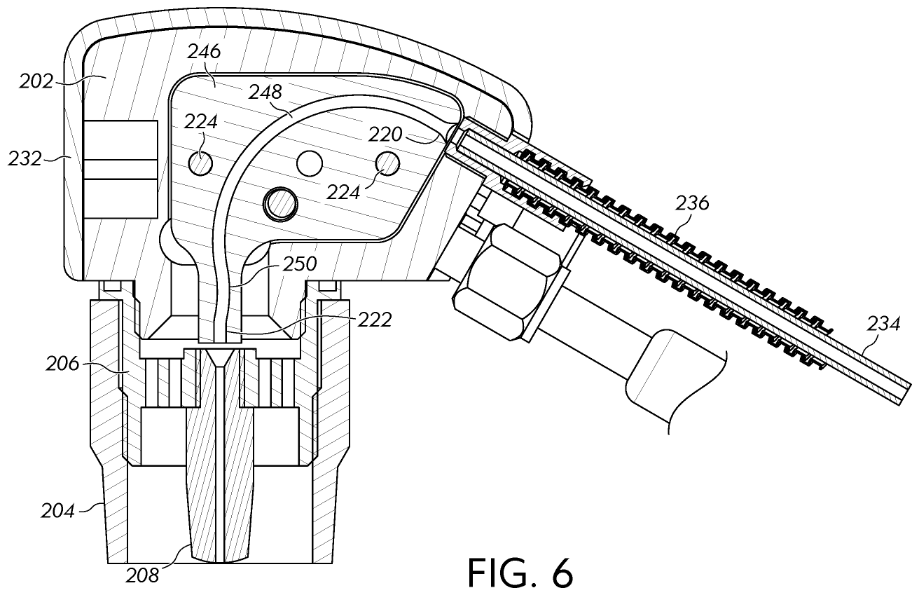

As noted above, in certain embodiments the wire guide channel can include a reverse bend located after the primary bend, to straighten the wire electrode before it is discharged from the torch. An example of a wire guide 246 having a wire guide channel with a reverse curve shape or S-curve shape is shown in FIG. 6. The wire guide channel has a primary bend or first curved portion 248 followed by a reverse bend or second curved portion 250. The first curved portion 248 is located between the wire receiving end 220 of the wire guide channel and the second curved portion 250. The second curved portion 250 is located between the first curved portion 240 and the wire discharge end 222 of the wire guide channel. It can be seen that the first curved portion 248 and the second curved portion 250 are curved in opposite directions from each other. The second curved portion 250 introduces a reverse bend to the wire electrode to straighten it before it is discharged from the torch. The primary bend 248 could impart a permanent bend to the wire electrode so that the wire electrode would tend to curve away from the weld puddle as it exits the contact tip 208. The second curved portion 250 can remove such a permanent bend and straighten the wire electrode. In general, the first curved portion 248 can be substantially similar to the curved portion discussed above with respect to wire guide shown in FIG. 4 (e.g., have the same or similar radius and degree of bend with respect to the feeding direction of the wire electrode).

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. An electric arc torch, comprising:
a torch body;
a gas diffuser extending from a distal side of the torch body;
a contact tip attached to the gas diffuser and having a bore extending along a first axis;
a wire guide located within the torch body and having a wire guide channel that extends from a wire receiving end of the wire guide channel to a wire discharge end of the wire guide channel, wherein the wire discharge end is aligned with the bore of the contact tip; and
a wire electrode conduit extending from a lateral side of the torch body and configured to discharge a wire electrode into the wire receiving end of the wire guide channel and along a second axis, wherein an angle between the first axis and the second axis is not greater than 90 degrees.

2. The electric arc torch of claim 1, wherein a maximum length of the electric arc torch from a proximal side to the distal side is less than three inches.

3. The electric arc torch of claim 1, wherein the wire guide channel is an open channel along its length from the wire receiving end to the wire discharge end.

4. The electric arc torch of claim 3, further comprising a spare wire guide located within the torch body and having a further wire guide channel, wherein a surface of the spare wire guide opposite the further wire guide channel closes said open channel.

5. The electric arc torch of claim 1, wherein the angle between the first axis and the second axis is between 55 degrees and 65 degrees.

6. The electric arc torch of claim 1, wherein the angle between the first axis and the second axis is between 45 degrees and 75 degrees.

7. The electric arc torch of claim 1, wherein the wire guide channel has a first curved portion located between the wire receiving end and the wire discharge end.

8. The electric arc torch of claim 7, wherein a radius of the first curved portion is one inch or less.

9. The electric arc torch of claim 7, wherein the wire guide channel has a second curved portion located between the first curved portion and the wire discharge end, and wherein the second curved portion is curved in an opposite direction from the first curved portion and straightens a bend in the wire electrode caused by the first curved portion.

10. The electric arc torch of claim 1, wherein each of a shielding gas fitting, a cooling liquid fitting, a welding power connector, and a voltage sense connector extend from the lateral side of the torch body.

11. An electric arc torch, comprising:
a torch body;
a gas diffuser extending from a distal side of the torch body;
a contact tip attached to the gas diffuser and having a bore extending along a first axis;
a wire guide located within the torch body and having a wire guide channel that extends from a wire receiving end of the wire guide channel to a wire discharge end of the wire guide channel, wherein:
the wire guide channel has a reverse curve shape formed by a first curved portion and a second curved portion curved in an opposite direction from the first curved portion,
the first curved portion is located between the wire receiving end and the second curved portion, and is configured to turn a feeding direction of a wire electrode received at the wire receiving end by at least 90 degrees,
the second curved portion is located between the first curved portion and the wire discharge end, and
the wire discharge end is aligned with the bore of the contact tip.

12. The electric arc torch of claim 11, further comprising a wire electrode conduit extending from a lateral side of the torch body and configured to discharge the wire electrode into the wire receiving end of the wire guide channel and along a second axis, wherein an angle between the first axis and the second axis is not greater than 90 degrees.

13. The electric arc torch of claim 12, wherein the angle between the first axis and the second axis is between 55 degrees and 65 degrees.

14. The electric arc torch of claim 12, wherein the angle between the first axis and the second axis is between 45 degrees and 75 degrees.

15. The electric arc torch of claim 11, wherein a maximum length of the electric arc torch from a proximal side to the distal side is less than three inches.

16. The electric arc torch of claim 11, wherein the wire guide channel is an open channel along its length from the wire receiving end to the wire discharge end.

17. The electric arc torch of claim 16, further comprising a spare wire guide located within the torch body and having a further wire guide channel, wherein a surface of the spare wire guide opposite the further wire guide channel closes said open channel.

18. The electric arc torch of claim 11, wherein a radius of the first curved portion is one inch or less.

19. The electric arc torch of claim 11, wherein each of a shielding gas fitting, a cooling liquid fitting, a welding power connector, and a voltage sense connector extend from the lateral side of the torch body.

20. An electric arc torch, comprising:
a torch body;
a contact tip having a bore extending along a first axis;
a wire guide located within the torch body and having a wire guide channel that extends from a wire receiving end of the wire guide channel to a wire discharge end of the wire guide channel, wherein the wire discharge end is aligned with the bore of the contact tip; and
a wire electrode conduit extending from a lateral side of the torch body and configured to discharge a wire electrode into the wire receiving end of the wire guide channel and along a second axis, wherein an angle between the first axis and the second axis is not greater than 135 degrees.

21. The electric arc torch of claim 20, wherein a maximum length of the electric arc torch from a proximal side to the distal side is less than three inches.

22. The electric arc torch of claim 20, wherein the wire guide channel is an open channel along its length from the wire receiving end to the wire discharge end.

23. The electric arc torch of claim 22, further comprising a spare wire guide located within the torch body and having a further wire guide channel, wherein a surface of the spare wire guide opposite the further wire guide channel closes said open channel.

24. The electric arc torch of claim 20, wherein the wire guide channel has a first curved portion located between the wire receiving end and the wire discharge end.

25. The electric arc torch of claim 24, wherein a radius of the first curved portion is one inch or less.

26. The electric arc torch of claim 24, wherein the wire guide channel has a second curved portion located between the first curved portion and the wire discharge end, and wherein the second curved portion is curved in an opposite direction from the first curved portion and straightens a bend in the wire electrode caused by the first curved portion.

27. The electric arc torch of claim 20, wherein each of a shielding gas fitting, a cooling liquid fitting, a welding power connector, and a voltage sense connector extend from the lateral side of the torch body.
